(19) United States
(12) Patent Application Publication
(10) Pub. No.: US 2019/0219027 A1
(43) Pub. Date: Jul. 18, 2019

(54) Vortex P3M3 Omega-B3

(71) Applicant: Edgardo Co Timcang, Vallejo, CA (US)

(72) Inventor: Edgardo Co Timcang, Vallejo, CA (US)

(21) Appl. No.: 15/732,970

(22) Filed: Jan. 16, 2018

(51) Int. Cl. F03B 17/00

(52) U.S. Cl. CPC F03B 17/005

(57) ABSTRACT

When water is pumped manually to the overhead tank, the Weight of the water is felt on the opposite end of the lever. Thus, an equal or heavier Weight to counter that Weight is thought of. This idea works on the Output Process but not on the Input Operation. However, unlike conventional water pumps, P3M3 works on both processes using techniques (invention) that employ the underlying Principles of Equilibrium or Perfect Balance. These techniques constitute the secret of P3M3, a very powerful synchronized tri-lever perpetual motion machine capable of using equal or heavier Weights to counter the Weights on the other end of the lever on both the Input and the Output Operations. Therefore, since it is perfectly balanced, pumping out 2 cubic meters of water per stroke through a 1.6-meter diameter 100-meter high pipe, with total water Weight of 200 tons, becomes an easy task for P3M3 since it is only the friction or mechanical losses of very few moving parts and the behavior of the pressurized hydraulic fluid or water that must be overcome.

Please note that Cangrier-M1 or C-M1, with U.S. patent application Ser. No. 12/231,697, Cangrier-M87 or C-M87, with U.S. patent application Ser. No. 12/586,975, C-M3 the G-Force Emulator (as power source only) with U.S. patent application Ser. No. 12/288,988, Vortex P2M2 Omega with U.S. patent application Ser. No. 15/731,912 or P2M2 and Vortex P3M3 Omega-B3 or P3M3 are four of the 7 versions of Cangrier-M Perpetual Motion Machines Line-up.

### BACKROUND OF THE INVENTION

My quest for a machine that runs without the need of any fossil fuel, nuclear, or any prime mover that needs consumable materials or elements, started in August 1970 in my Earth Science subject. It started when one of my classmates raised the question on how to control air, water and noise pollution and radiation (climate change is not an issue then). Then somebody answered: “Ma'am, through perpetual motion machine!”. Henceforth, my research and study for that elusive machine has been born and intensified. Time, effort, and money were all focused on how to discover such machine. I have also read and heard about perpetual motion machines run by gravity, flywheel, spring, magnet, electromagnet, but all are bulky and impracticable since most will stop running even if a minuscule Weight is loaded. I concentrated on known renewable energies as well, but all have limitations and drawbacks. Because of these imperfections, my research and experiment persisted. I continued such endeavor when I worked in Bahrain and Saudi Arabia, and when I was back in the Philippines.

Sometime in early 1980s, I became interested in water pumps. I devoted myself on studying it extensively. Then suddenly, in mid 1980s, the first clue came flashing into my mind. If the Weight of the water inside the pipe, that is from the tip of the piston all the way down to the tip of the pipe, is counterbalanced by the same Weight on the other end of the lever, then pumping out such Weight of water (Output Operation) can be made even through the tip of my finger. But how about the water intake (Input Operation) where the piston draws water from the supply source where, in such Operation, the valve is closed? The same problem will occur! Only this time, the Weight problem is shifted to the counter weight instead of the water weight. How can we solve this problem? This is precisely the reason why another Cangrier-M Perpetual Motion Machine, the P3M3, has been discovered lately and finally perfected and invented.

### BRIEF SUMMARY OF THE INVENTION

In general, the principle and concept of P3M3, along with its predecessors, is the basic of all basics. It adapts the underlying principles of equilibrium where a lever is used to pump water. However, P3M3, unlike ordinary water pumps, employs Techniques (the invention) that have not been discovered since time immemorial? These techniques made P3M3 one of the most powerful machine ever invented and the most amazing discovery is that it is a perpetual motion machine! The saying that “I can lift a mountain through the tip of my finger” is no longer an exaggeration but a reality. Pumping out water or any liquid, no matter how heavy, high or deep, can be easily done by P3M3. How? By applying the Techniques and the underlying Principles of Equilibrium on both Operations: The Input Operation and Output Operation—the secret of P3M3, which can help solve the great and infinite energy requirements of mankind on electric energy and various application that require prime mover here on earth and, in the immediate future, Vortex P3M3 Omega-B3 V3 powered by C-M3 the G-Force Emulator, the compact design of P3M3, which can replace the fossil-fuel-feed prime movers, and can be used in outer space.

P3M3 is by far incomparable to known perpetual motion machines, renewable energies, and known conventional prime movers. Unlike to known perpetual motion machines which stops even a very light weight is loaded, P3M3 is not. The more weight is loaded to P3M3 the more powerful it becomes. P3M3, unlike fossil fuel feed engines and nuclear power plant, does not pollute air and water. It does not produce sound, heat, smoke, waste, and radiation during operation; it does not contribute to air, water and noise pollution, and global warming; it does not cause fire or explosion since it uses water or hydraulic fluid, which is 100% safe to mankind. Compared to known renewable energies such as hydro, geothermal, solar, wind, sea wave, and sea current, all of which have drawbacks from their power sources, P3M3 does not have any from its power source—gravity. Gravity is consistent. Moreover, compared to all conventional prime movers having the same electric power capacity, it is 30% to 40% cheaper in short term investment and 80% to 90% cheaper in long term investment. When it comes to power generation, building an electric power plant using P3M3 as prime mover, it is 4 to 5 times faster than building a hydroelectric power plant and 2 to 3 times faster than building the other known renewable energies. Since it is a low RPM machine and has relatively few moving parts, it can even last for a century without breakdown. Therefore, blackouts and brownouts can be avoided. Because P3M3 is a noise-free and space saving machine, it can be built within a city or urban area. Due to this, expensive pylons, transmission lines, power generation equipment, land requirements and rentals, pilferage, sabotage, etc. can be minimized or eliminated. And astonishingly, it can be built anywhere, anytime! In general, since the concept of P3M3 is perfect balance, the only thing that It needs to overcome is the friction or mechanical losses on very few moving parts and the pressurized Hydraulic Fluid behavior to which in my estimate comprises around 5% from the total Weight. Therefore, it is safe to say that the ratio of Input to Output is 1:15 to 1:20. In power generation and combustion engine replacement two (2) P3M3 could be needed to prevent time lapses between input and output operation. As a pump for water, air or any form of liquid, etc. two (2) P3M3 is optional.

### BRIEF DESCRIPTION OF THE SEVERAL VIEWS OF DRAWINGS

To preclude obstruction of the view of the P3M3 machine's parts specifically the vital parts and moreover, to visualize clearly the operation and the workability of P3M3, the frame, foundation and platform are not drawn and some parts' length and width are expanded, rearranged for clearer presentation but do not affect the efficiency of the overall performance of P3M3. Actually, the drawings expound only on how P3M3 works using the Techniques and Principles of Equilibrium and not on how the discharged Hydraulic Fluid drives the Turbine. Using P3M3 in Electric Power Generation is just among its many uses. If P3M3 is used as water pump, regardless of the PSI generated by the Weight of the water, same (drawing) structure can be used in highland farming irrigation, water supply for highland cities, urban areas and high-rise buildings and condominium, firefighting equipment, cooling system, etc. Also, the same structure can be used as air pump for pneumatic tools and equipment.

1) The Vortex P3M3 Omega-B3 In Perspective

FIG. 1. The Front View of P3M3—the 3^{rd} Perfect Balance Methodical Approach—depicts the front view of the non-labeled parts of P3M3 where the Balancing Weight 31 is anchored at the Intake/Discharge Piston and Balancing Weight Lever 42 (D) instead of Operation Support Lever 9 of the P2M2 (F). It represents the whole P3M3 in a drawing form.

FIG. 2. The Front View of P2M2—the 2^{nd} Perfect Balance Methodical Approach—depicts the front view of the non-labeled parts of P2M2 where the Balancing Weight 31 is anchored at the Operation Support Lever 9 (F) instead of Intake/Discharge Piston and Balancing Weight Lever 42 of the P3M3. It represents the whole P2M2 in a drawing form.

FIG. 3 The Front View of P1M2—the 1^{st} Perfect Balance Methodical Approach—depicts the front view of the non-labeled parts of P1M2. P1M2 has only 1 lever. It represents the whole P1M2 in a drawing form.

FIG. 4. The Top and Front View of P3M3 Lever—the main purpose of this non-labeled drawing presentation is to depict the structure and positioning of the 3 levers and the cylinder on Top and Front perspective.

FIG. 5. The Front View of P3M3 with Part Label—depicts all labeled parts of the Machine.

2. P3M3 During The Intake Process

FIG. 6. The Start Position of Intake Process—(or End Position of Discharge/Output Process)—depicts the starting position of P3M3.

FIG. 7. The Continuing Position of Intake Process—depicts how P3M3 draws Hydraulic Fluid 18 from the Hydraulic Fluid Tank 17 into Intake/Discharge Chamber 28 during the Intake Process and the movement of the Intake/Discharge Piston 26 and Pressure Weight Piston 5 and the Intake Valve 19 and the Discharge Valve 29 positions.

FIG. 8. The End Position of Intake Process (or Start Position of Discharge/Output Process)—depicts the ending position of P3M3.

3. P3M3 During The Discharge/Output Process

FIG. 9. The Start Position of Discharge/Output Process (or End Position of Intake Process)—depicts the starting position of P3M3.

FIG. 10. The Continuing Position of Discharge/Output Process—depicts how P3M3 discharges the Hydraulic Fluid 18 into the Pressure Weight Chamber 7 during the Discharge/Output Process and the movement of Intake/Discharge Piston 26 and the Pressure Weight Piston 5 and the Intake Valve 19 and Discharge Valve 29 positions.

FIG. 11. The End Position of Discharge/Output Process (or Start Position of Intake Process)—depicts the ending position of P3M3.

4. P3M3 Other Applications Drawing

FIG. 12 The P3M3 Drawing as a Water Pump—the drawing depicts P3M3 as a water pump. This version of P3M3 design is to pump water for: Hydroelectric Water Recycling Concept; highland Urban and Rural areas; irrigation for highland farming; high rise buildings, hotels and condominiums; highland reservoir for fighting forest fires; fire-fighting equipment; cooling system in centralized air conditioning and ice plant; dewatering flooded areas; etc.; and to pump air for pneumatic tools. However, for presentation purposes, I just used the same drawing with minor alteration.

FIG. 13 The P3M3 Drawing With G-Force Emulator or C-M3—the drawing depicts the P3M3 adapting the G-Force Emulator technology replacing Pressure Weight 1 and Balancing Weight 31. This design is the compact version of P3M3 and is intended to replace fossil-fuel-feed engines and other prime movers. However, for purposes of presentation, I just used the same drawing with minor alteration.

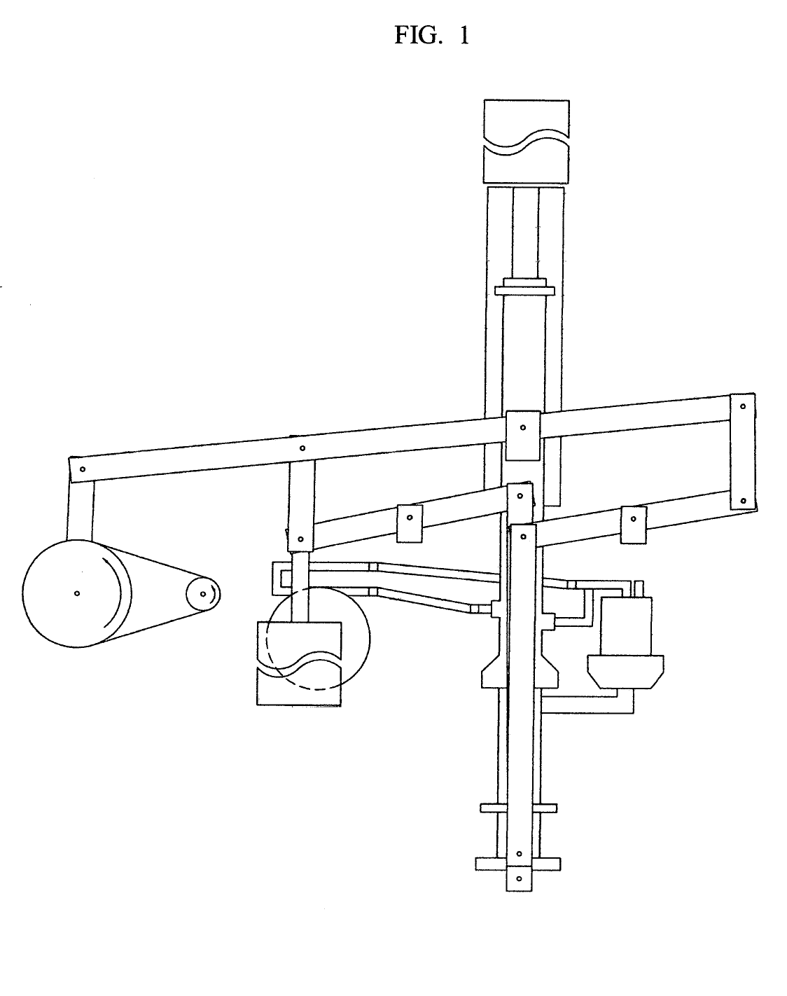

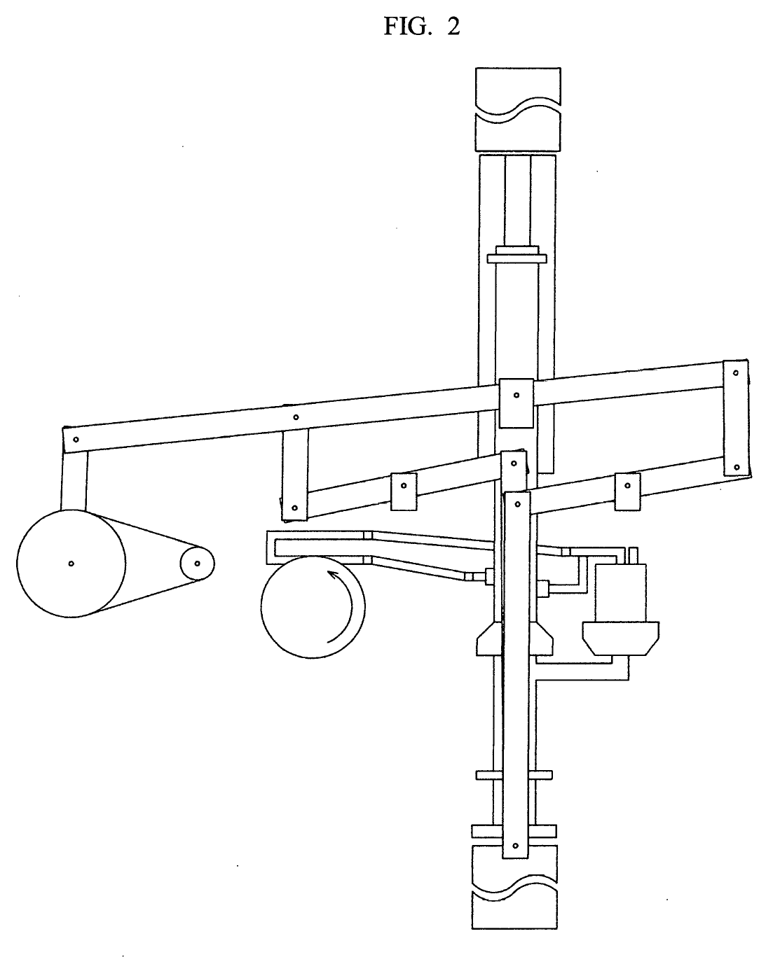

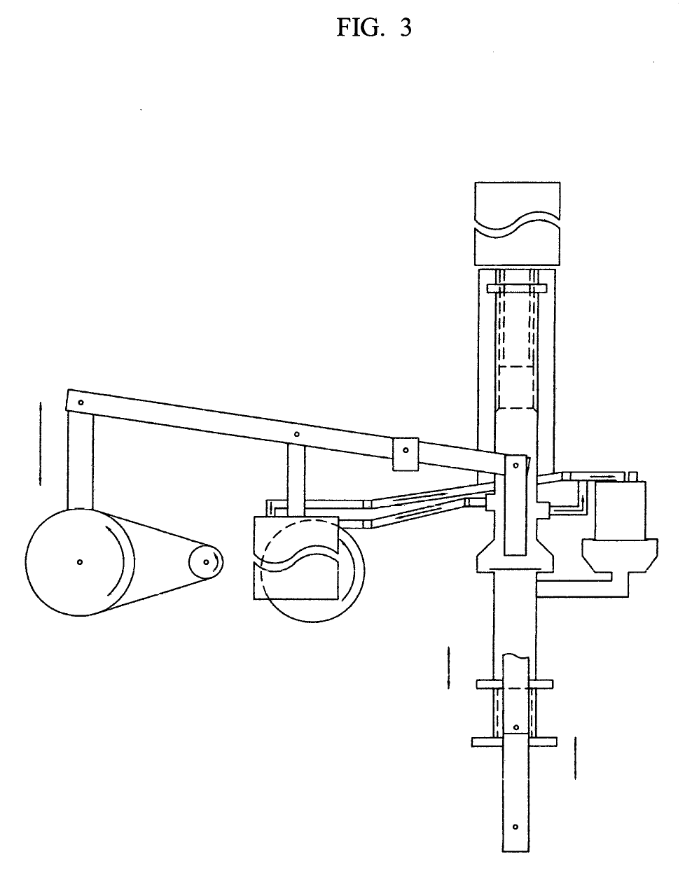

### DETAILED DESCRIPTION OF THE INVENTION

In all honesty, P3M3's technical aspect is simple. P3M3 is a machine which is basic of all basics. It works primarily on the Techniques and the underlying Principle of Equilibrium. But how does P3M3 handle the Input and Output Operations, the known problem since man has existed? P3M3 has employed simple techniques that have not been discovered since time immemorial? These techniques are fully described and consolidated in the illustration of P3M3 Embodiments.

1) P3M3 Components
A. P3M3 2 Operation Assemblies
   1. Operation Support Assembly
      A. Supports the Discharge/Output Assembly's production requirements.
      B. Composed of part nos.: 7, 10, 12, 14-22, 25, 29-30 and 32.
   2. Discharge/Output Operation Assembly
      A. The production assembly that works on Operation Support Assembly services.
      B. Composed of part nos.: 1-2, 5, 24, 26, 28, 31, 33-35,37-39, 41-46.
   Note: To simplify the process of presentation, some P3M3 parts which I deemed not necessary in proving the process like momentum spring—which equate the momentum of the up-and-down movement of the levers; pouch—which prevents the fluid or liquid leakage between the Intake/Discharge Chamber 28 and Intake/Discharge Piston 26 and Pressure Weight Chamber 7 and Pressure Weight Piston 5; stopper—which prevents pistons and levers exceed from their designed travel; things that minimize frictions—slippery materials like hardened Teflon, bearings and proper alignment; flywheel—which maintains and controls the smooth revolution of the machine per minute or RPM; etc., all of which are performance enhancers are not included in the drawing.
B. Weights—since P3M3 is dealing with weights, I need to define and describe the three most important actual weights significant to the machine's workability.
   1. Machine Weight—the total weight of 8, 14—22, 29, 30 and 32.
   2. Pressure Weight—the total weight of 1, 2 and 5.
   3. Balancing Weight—the weight that is added to Machine Weight to counter the weight of Pressure Weight 1.
   Note: travel restrictions, guides, stands, levers and rods are not included.
C. Parts and Functions:
   1. Pressure Weight (or C-M3 or Water Weight)—the calculated weight that creates pressure power required by an application.
   2. Pressure Weight Connecting Rod—the rod that connects the Pressure Weight 1 to the Pressure Weight Piston 5.
   3. Cylinder Travel: Top Part—the restricted up-and-down movement of Operation Support Assembly at the upper level.
   4. Upper Machine Vertical Movement Guide—this guide is perfectly and vertically aligned to the Lower Machine Vertical Movement Guide 25. This will prevent the Operation Support Assembly to tilt or lean on either way. Its function is to ensure the restricted smooth up-and-down vertical movement of the machine.
   5. Pressure Weight Piston—used by the Pressure Weight 1 to push the Hydraulic Fluid 18 out to the opened Gate Valve 30, in this case, into the turbine of the Turbine and Electric Generator 33.
   6. Pressure Weight Piston Travel—the restricted up-and-down movement of the Pressure Weight Piston 5.
   7. Pressure Weight Chamber—part of the Cylinder 8 where Pressure Weight Piston 5 travels and pushes the Hydraulic Fluid 18 down to the Gate Valve 30 to run the Turbine and Electric Generator 33. Its area is around half, and length is twice as the Intake/Discharge Chamber 28.
   8. Cylinder—the pipe that stretched from the Intake/Discharge Piston 26 to the Pressure Weight Piston 5.
   9. Operation Support Lever—the lever which the Operation Support Assembly is anchored.
   10. Operation Support Lever Stand—the stand that holds in place the Operation Support Lever 9.
   11. Tandem Lever Travel—the restricted up-and-down movement of the Tandem Lever 44.
   12. Tandem Lever Pull Rod for Operation Support Lever—the push and pull rod that connects the Tandem Lever 44 (C) to the Operation Support Lever 9.
   13. Operation Support Lever Travel—the restricted up-and-down movement of the Machine Weight Lever 9.
   14. Operation Support Pull Rod—the push and pull rod that directly connects the Machine Weight to the Operation Support Lever 9.
   15. Hydraulic Fluid Tank Air Vent—ensures air flow into the Hydraulic Fluid Tank 17 during Intake Process and Discharge/Output Process.
   16. Hydraulic Fluid Receiver Conduit—receives the Hydraulic Fluid 18 coming from the Intake Hydraulic Hose 20 and the Check Valve 21.
   17. Hydraulic Fluid Tank—stores the recycled Hydraulic Fluid 18 coming from the Intake Hydraulic Hose 20 and the Check Valve 21 during Discharge/Output Process and releases the Hydraulic Fluid 18 during the Intake Process.
   18. Hydraulic Fluid (Water or Air)—the life blood of P3M3.
   19. Intake Valve—opens during the Intake Process and closes during the Discharge/Output Process. 20. Intake Hydraulic Hose (or Intake Ball Joint Pipe)—the conduit where discharged Hydraulic Fluid 18 exiting from the turbine flows back to the Hydraulic Fluid Tank 17.
   21. Check Valve—checks and maintains the desired pressure inside the entire Cylinder 8 during the Discharge/Output Process and opens during the Intake Process.
   22. Intake Supply Pipe—conduit between the Hydraulic Fluid Tank 17 and the Intake/Discharge Chamber 28 where the Hydraulic Fluid 18 flows.
   23. Cylinder Travel: Bottom Part—the restricted up-and-down movement of Operation Support Assembly at the lower level.
   24. Intake/Discharge Connecting Rod—the connecting rod of the Intake/Discharge Piston 26.
   25. Lower Machine Vertical Movement Guide—this guide is perfectly and vertically aligned to the Upper Machine Vertical Movement Guide 4. It prevents the entire P3M3 Support Assembly to tilt or lean on either way and ensures the restricted smooth up-and-down vertical movement.
   26. Intake/Discharge Piston—draws Hydraulic Fluid 18 from the Hydraulic Fluid Tank 17 through the Intake Supply Pipe 22 and stores it into the Intake/Discharge Chamber 28 during the Intake Process and discharges it into the Cylinder 8 up to the Pressure Weight Chamber 7 during Discharge/Output Process.
   27. Intake/Discharge Piston Travel—the restricted up-and-down movement of the Intake/Discharge Piston 26.
   28. Intake/Discharge Chamber—part of the Cylinder 8 where drawn Hydraulic Fluid 18 is stored during Intake Process and releases it during Discharge/Output Process.
   29. Discharge Valve—opens during Discharge/Output Process, closes during Intake Process.
   30. Gate Valve—where Hydraulic Fluid 18 from Pressure Weight Chamber 7 passes through going into the Discharge Hydraulic Hose 32 driving the turbine of the Turbine and Electric Generator 33. This valve opens only during the Discharge/Output Process.
   31. Balancing Weight—the weight needed, in addition to Machine Weight, to counter the total Weight of the Pressure Weight 1.
   32. Discharge Hydraulic Hose (or Ball Joint Pipe)—a flexible hose, whose one end is connected to the Turbine and Electric Generator 33 and the other end is connected to the Gate Valve 30 that moves along with the Operation Support Assembly's travel.
   33. Turbine and Electric Generator—generates electricity.
   34. Crankshaft Driver Electric Motor—drives the Crankshaft 37 which push and pull the Extended Tandem Lever Connecting Rod 38 of the Extended Tandem Lever 39 (A).
   35. Intake/Discharge Piston Pull Rod—the push and pull rod that directly connects the Intake/Discharge Piston 26 to the Intake/Discharge Piston and Balancing Weight Lever 42 (E).
   36. Intake/Discharge Piston and Balancing Weight Lever Travel—the restricted up-and-down movement of Intake/Discharge Piston and Balancing Weight Lever 42 (D).
   37. Crankshaft—designed to push and pull the Extended Tandem Lever 39 by means of the Extended Tandem Lever Connecting Rod 38.
   38. Extended Tandem Lever Connecting Rod—the rod that connects the Extended Tandem Lever 38 to Crankshaft 37.
   39. Extended Tandem Lever—the extended length of the Tandem Lever 44 which is the result of the reverse Tri-Lever Technology, one of the two secrets of the P3M3 invention.
   40. Extended Tandem Lever Travel—the restricted up-and-down movement of Extended Tandem Lever 39.
      Please note that the length of travel of Extended Tandem Lever 39 is the same as the Intake/Discharge Piston 26 travel inside the Intake/Discharge Chamber 28. This is due to the reverse Tri-Lever Technology.
   41. Tandem Lever Pull Rod for Intake/Discharge Piston and Balancing Weight Lever—the push and pull rod that connects the Tandem Lever 44 (B) to Intake/Discharge Piston and Balancing Weight Lever 42 (D).
   42. Intake/Discharge Piston and Balancing Weight Lever—the lever of which the Balancing Weight 31 (D) and Intake/Discharge Piston 26 (E) are anchored.
   43. Intake/Discharge Piston and Balancing Weight Lever Stand—the stand that holds in place the Intake/Discharge Piston and Balancing Weight Lever 42.
   44. Tandem Lever—the lever that holds in tandem the Tip G of Operation Support Lever 9 and the Tip D of the Intake/Discharge Piston and Balancing Weight Lever 42.
   45. Tandem Lever Stand—the stand that holds in place the Tandem Lever 44.
   46. Pressure Weight Rest Rod—actually, this is part of the Intake/Discharge Piston and Balancing Weight Lever 42 (E) wherein the Pressure Weight 1 rests immediately after the Discharge/Output Process cycle is completed.
      Note: The Pressure Weight Rest Rod 46 is aligned with and on the top of the Intake/Discharge Piston Pull Rod 35. However, to prevent obstruction the rod drawing of Pressure Weight Rest Rod 46 is just drawn alongside Cylinder 8.

2) P3M3 Operation Defined and Described
A. Types of Output Operations of Vortex P*M* Omega Series
   1. The Direct Output Process—the process of discharging the Hydraulic Fluid 18 from the Intake/Discharge Chamber 28 into the Cylinder 8 creating high pressure between Pressure Weight Piston 5 and the Intake/Discharge Piston 26 and running the application, in this case, the Turbine and Electric Generator is done simultaneously. This process can be used by either P2M2 or P3M3.
   2. The Delayed Output Process—the process of discharging the Hydraulic Fluid 18 from the Intake/Discharge Chamber 28 into the Cylinder 8 thereby creating high pressure between Pressure Weight Piston 5 and the Intake/Discharge Piston 26. Running the Turbine and Electric Generator 33 application is done only when the discharging is completed. This process can be used by either P3M3 or P2M2.
B. Types of Input Operations of Vortex P*M* Omega Series
   1. The Common Input Process—the usual process, that is input must be completed first before an output takes place.
   2. The Input/Discharging Process—in this process the storing of Hydraulic Fluid 18 into Intake/Discharge Chamber 28 and the discharging of non-pressurized Hydraulic Fluid 18 back into the Hydraulic Fluid Tank 17 is done simultaneously.
   Note: P3M3 and P1M2 uses the “Direct Output” and “Input/Discharging” techniques while P2M2 uses the “Delayed Output” and Input/Discharging.
C. The Input/Output Operations of Vortex P3M3 Omega Series
   1. Intake Process: the process where the Intake/Discharge Piston 26 draws Hydraulic Fluid 18 from the Hydraulic Fluid Tank 17 which passes through the Intake Valve 19, the Intake Supply Pipe 22 and finally stores it in the Intake/Discharge Chamber 28. In this process, the Intake Valve 19 is open while the Discharge Valve 29 is closed. The Intake/Discharge Piston and Balancing Weight Lever 42's Tip D travels in an upward direction while Its Tip E travels in a downward direction. The Operation Support Lever 9's Tip F travels in an upward direction while Its Tip G travels in a downward direction.
   2. Discharge/Output Process:—the process where the Intake/Discharge Piston 26 discharges Hydraulic Fluid 18 from the Intake/Discharge Chamber 28 which passes through the Discharge Valve 29, the Cylinder 8 and finally stores it in the Pressure Weight Chamber 7. In this process, the Intake Valve 19 is closed while the Discharge Valve 29 is open. The Intake/Discharge Piston and Balancing Weight Lever 42's Tip D travels in a downward direction while Its Tip E travels in an upward direction. The Operation Support Lever 9's Tip F travels in a downward direction while Its Tip G travels in an upward direction.
      Note: when the Intake/Discharge Piston 26 discharges Hydraulic Fluid 18 from the Intake/Discharge Chamber 28 exiting through the Discharge Valve 29 going to the Pressure Weight Chamber 7, the pressure created by the opposing Pressure Weight Piston 5 and the discharging Intake/Discharge Piston 26 is directly felt and in this method the Gate Valve 30 opens automatically thereby running the Turbine and Electric Generator 33.

3. P3M3 Housekeeping
Before running the P3M3, whether it is the first time or from repair or maintenance the following housekeeping must be undertaken:
A. Calibration/Preparation
   1. Balancing Weight—the calculated weight added to the Operation Support Assembly to counter the weight of Pressure Weight 1.
   2. Momentum Spring—to be calibrated on how to counter the momentum of one end of the lever that has downward force where upon reaching the end of the travel the compressed Momentum Spring can give a backward push.
   3. Friction or Mechanical Losses—calculating how much energy or force needed by an electric motor to overcome the friction and the pressurized Hydraulic Fluid 18 behavior to run the Turbine and The Electric Generator 33 according to the desired revolution per minute or RPM.
B. Priming
   Filling the Operation Support Assembly's Hydraulic Fluid Tank the amount of Hydraulic Fluid 18 needed by the Intake Process or Discharge/Output Process.

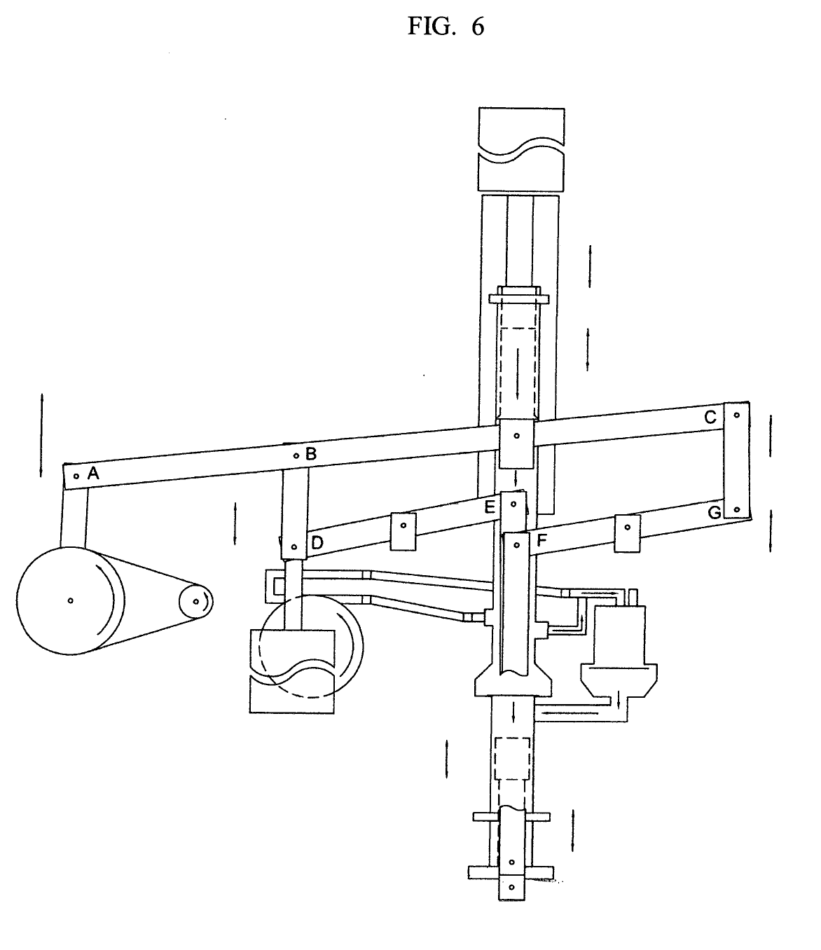

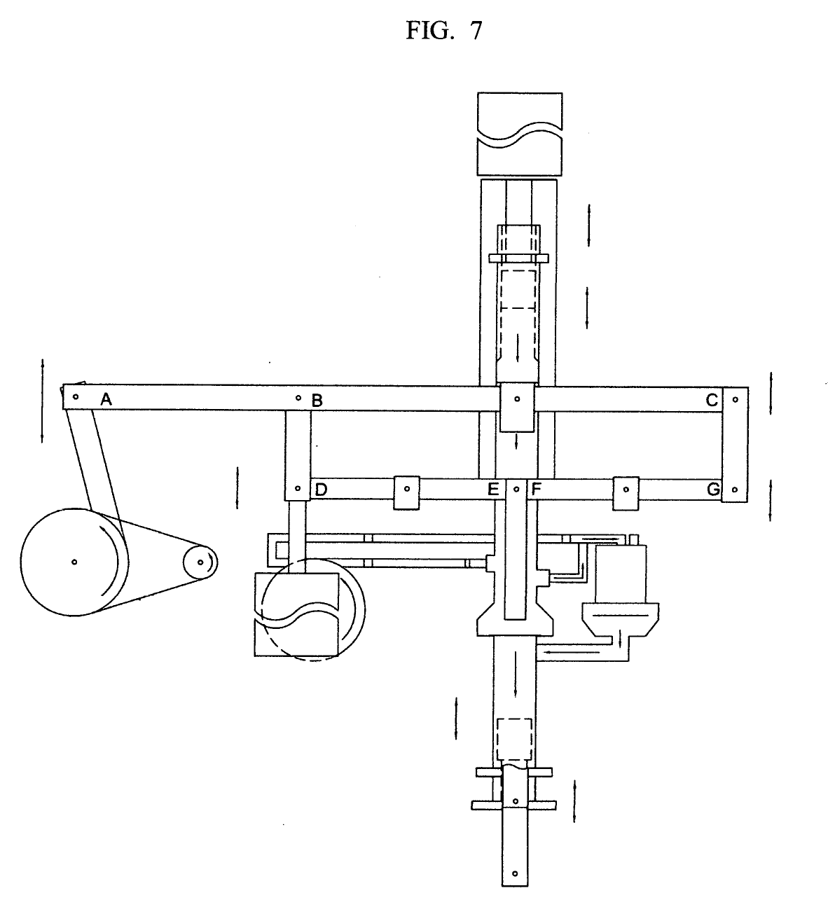

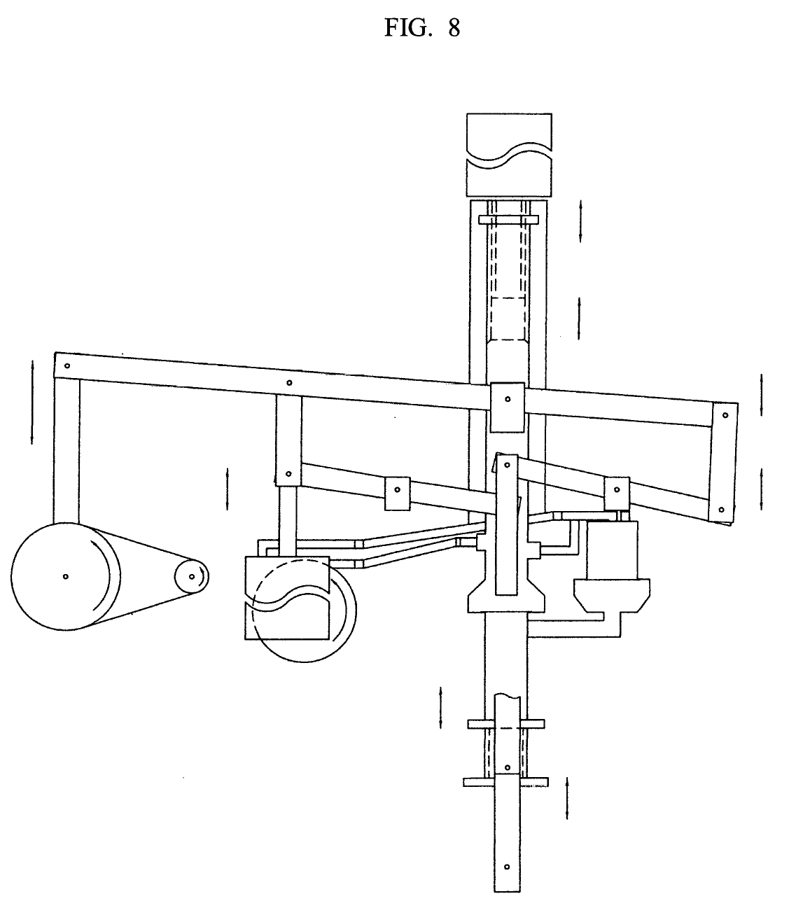

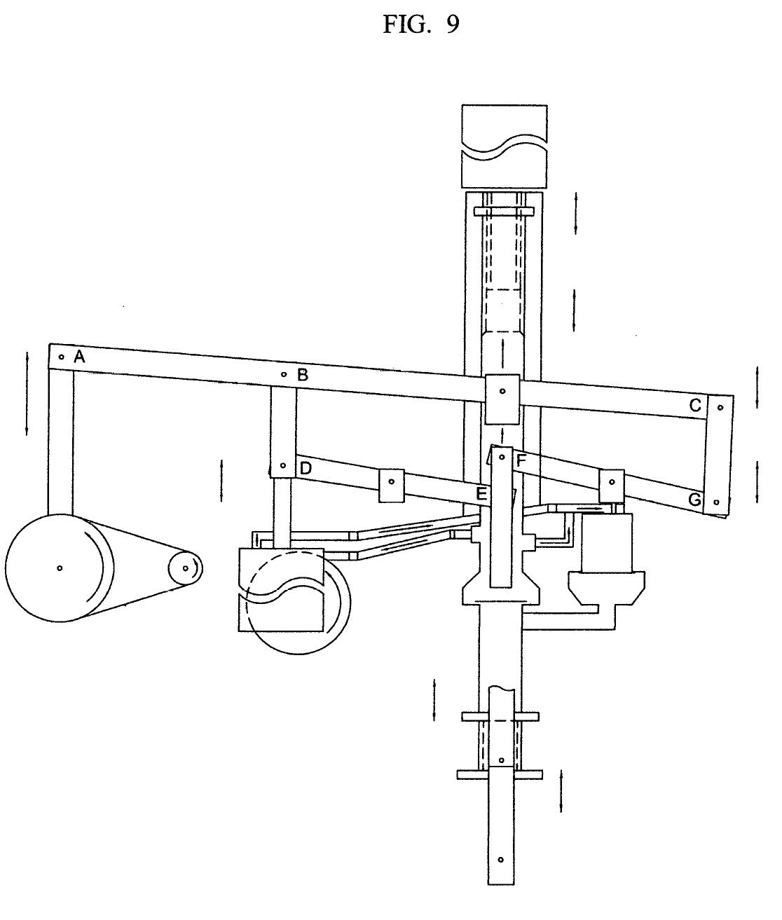

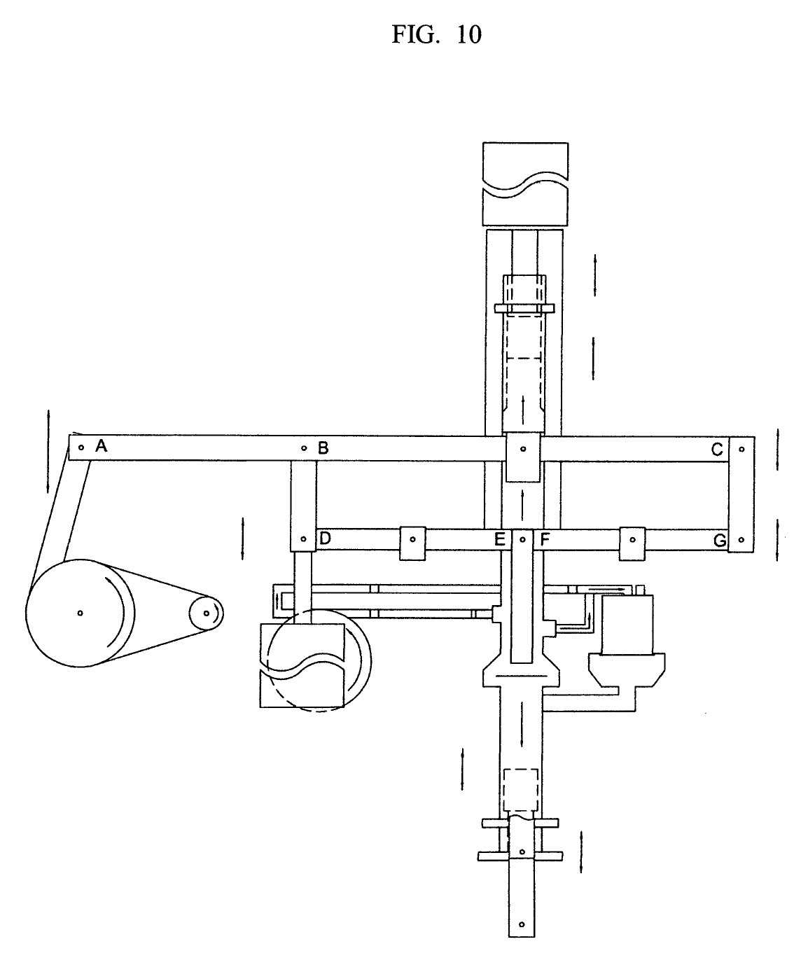

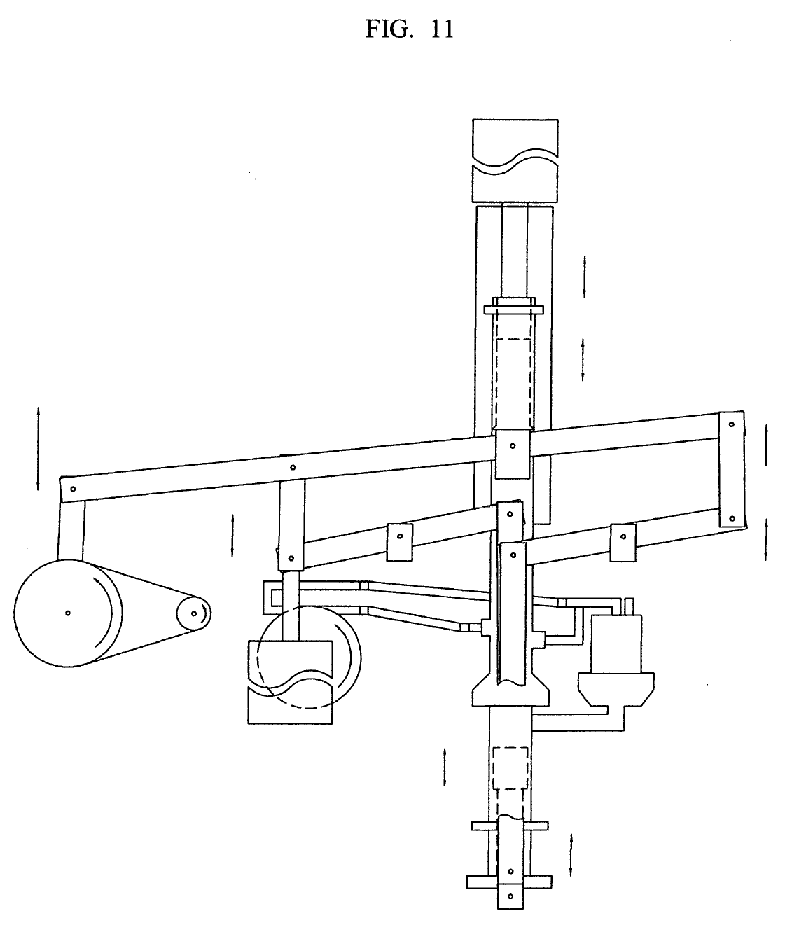

4) P3M3 Embodiments
The Intake and Discharge/Output Operations of P3M3
With most, if not all, of P3M3's significant terminologies have been defined and their functions described, I hope that with the aid of drawings P3M3's workability can be easily understood. Please note that the P3M3 Start Position of the Intake Process FIG. 6 and the P3M3 End Position of the Discharge/Output Process FIG. 11 are the same. Likewise, the End Position of the Intake Process FIG. 8 and the Start Position of the Discharge/Output Process FIG. 9 are also the same. Although there is a sort of drawing duplication, the objective is to show clearly both the Intake Valve 19 and the Discharge Valve 29 of the above processes are closed, a complete process that is from the start to the end on both processes. There are also similarities between the drawings of the Continuing Position of the Discharge/Output Process FIG. 10 and the Continuing Position Intake Process FIG. 7. However, the difference between the two is their valve positioning, the Intake Valve 19 is open while the Discharge Valve 29 is closed during the Intake Process while the Intake Valve 19 is closed, and Discharge Valve 29 is open during the Discharge/Output Process.
A. Intake Process
   In this process, the Intake/Discharge Piston 26 draws Hydraulic Fluid 18 from the Hydraulic Fluid Tank 17 all the way to the Intake/Discharge Chamber 28. Simultaneously, the Pressure Weight 1 pushes the non-pressurized Hydraulic Fluid 18 towards the Check Valve 21, which is open, back to Hydraulic Fluid Tank 17. Please refer to FIGS. 6, 7 and 8. Please note that immediately before the Intake Process starts the Pressure Weight 1 already rests or sits on the Pressure Weight Rest Rod 46.
   1. FIG. 6 The Start Position of the Intake Process
      A. Valves—Intake Valve 19 and Check Valve 21 open; Gate Valve 30 and Discharge Valve 29 close.
      B. Lever and Piston Direction—Tip F, Tips A and B and Tip D start traveling upward. Tip C, Tip E and Tip G, Intake/Discharge Piston 26 and Pressure Weight Piston 5 start traveling downward.
      C. Intake/Discharge Piston 26 starts drawing the Hydraulic Fluid 18 from the Hydraulic Fluid Tank 17 through the Intake Supply Pipe 21 and storing it into the Intake/Discharge Chamber 28. Non-pressurized Hydraulic Fluid 18 from Pressure Weight Chamber 7 starts flowing towards the Hydraulic Fluid Tank 17.
   2. FIG. 7 The Continuing Position of the Intake Process
      A. Valves—Intake Valve 19 and Check Valve 21 remain opened; Gate Valve 30 and Discharge Valve 29 remain closed.
      B. Lever and Piston Direction—Tip F, Tips A and B and Tip D continue traveling upward. Tip C, tip E and Tip G of the Intake/Discharge Piston 26 and Pressure Weight Piston 5 continue traveling downward.
      C. Intake/Discharge Piston 26 continues drawing the Hydraulic Fluid 18. Hydraulic Fluid 18 from Pressure Weight Chamber 7 continues flowing towards Hydraulic Fluid Tank 17.
   3. FIG. 8 The End Position of the Intake Process
      A. Valves—Intake Valve 18 and Check Valve 21 closed; Gate Valve 30 and Discharge Valve 29 closed.
      B. Lever and Piston Direction—Tip F, Tips A and B and Tip D stop traveling upward. Tip C, tip E and Tip G of the Intake/Discharge Piston 26 and Pressure Weight Piston 4 stop traveling downward.
      C. Intake/Discharge Piston 26 stops drawing the Hydraulic Fluid 18 from Hydraulic Fluid 17. Likewise, Hydraulic Fluid 18 from Pressure Weight Chamber 7 stops flowing towards Hydraulic Fluid Tank 17.
B. Discharge I Output Process
   In this process, the Intake/Discharge Piston 26 discharges the Hydraulic Fluid 18 from the Intake/Discharge Chamber 28 through the Cylinder 8 towards its destination which is the Pressure Weight Chamber 7. Please note that once the Intake/Discharge Piston 26 starts discharging the Hydraulic Fluid 18 into the Cylinder 8 going to Pressure Weight Chamber 7, the Pressure Weight 1 leaves the Pressure Weight Rest Rod 46. 1. FIG. 9 The Start Position of the Discharge/Output Process
      A. Valves—Discharge Valve 29 and Gate Valve 30 open; Check Valve 21 and Intake Valve 18 close.
      B. Lever and Piston Direction—Tip F, tips A and B and Tip D start traveling downward. Tip C, Tip E and Tip G of the Intake/Discharge Piston 26 and Pressure Weight Piston 5 start traveling upward.
      C. Intake/Discharge Piston 26 starts discharging the Hydraulic Fluid 18 from the Intake/Discharge Chamber 28 into the Cylinder 8 going to the Pressure Weight Chamber 7 creating tremendous pressure due to Pressure Weight's 1 counter force. During the discharging process half of the discharged Hydraulic Fluid 18 flows towards the turbine of the Turbine and Electric Generator 33 passing through the opened Gate Valve 30. Please refer to FIGS. 9, 10 and 11.
   2. FIG. 10 The Continuing Position of the Discharge/Output Process
      A. Valves—Discharge Valve 29 and Gate Valve 30 remain opened; Check Valve 21 and Intake Valve 18 remain closed.
      B. Lever and Piston Direction—Tip F, Tips A and B and Tip D continue traveling downward. Tip C, Tip E and Tip G of the Intake/Discharge Piston 26 and Pressure Weight Piston 5 continue traveling upward.
      C. Intake/Discharge Piston 26 continues discharging the Hydraulic Fluid 18 from the Intake/Discharge Chamber 28 into the Cylinder 8 going to the Pressure Weight Chamber 7 maintaining the constant pressure while half of the discharged Hydraulic Fluid 18 continues flowing towards the turbine of the Turbine and Electric Generator 33 passing through the opened Gate Valve 30.
   3. FIG. 11 The End Position of the Discharge/Output Process
      A. Valves—Discharge Valve 29 and Gate Valve 30 closed; Check Valve 21 and Intake Valve 18 closed.
      B. Lever and Piston Direction—Tip F, tips A and B and Tip D stop traveling downward. Tip C, Tip E and Tip G of the Intake/Discharge Piston 26 and Pressure Weight Piston 5 stop traveling upward.
      C. Intake/Discharge Piston 26 stops discharging the Hydraulic Fluid 18 while half of the discharged Hydraulic Fluid 18 stops flowing towards the turbine of the Turbine and Electric Generator 33.

1. that the P3M3 Tri-Lever Technology's unfolding secret is the Tandem Lever where two synchronized opposite position sub-levers are connected, namely the Intake/Discharge Piston and Balancing Weight Lever 42 and the Operation Support Lever 9.

2. that due to the P3M3 Tri-Lever Technology the up-and-down movement of the Operation Support Assembly and the Discharge/Output Operation Assembly has resulted to opposite travel direction during operation a technique that cuts the travel time and distance distance of the 3 levers by 50% yet the travel of Intake/Discharge Piston 26 inside the Intake/Discharge Chamber 28 is in full distance (100%) and likewise, the travel of Pressure Weight Piston 5 inside the Pressure Weight Chamber 7 is also in full distance in Discharge/Output Process.

3. that due to the P3M3 Tri-Lever Technology the length of Tandem Lever 44 from its one end to the fulcrum point is also the length of the Extended Tandem Lever 39 and the travel distance of Extended Tandem Lever 39 Tip A is equal and proportionate to the travel distance of the Intake/Discharge Piston 26 inside the Intake/Discharge Chamber 28 which is one of the secret of P3M3, a 100% gain on lever length but within the principle of equilibrium.

4. that P3M3 uses the “Direct Output” technique which discharging Hydraulic Fluid 18 from the Intake/Discharge Chamber into Cylinder 8 thereby creating pressure due to Pressure Weight 1 and running the application are done simultaneously.

5. that the area of circumference of Pressure Weight Chamber 7 is around half and the length is twice than that of Intake/Discharge Chamber 28.

6. that P3M3 adapts the Rest Rod (Pressure Weight Rest Rod 46) technique to regain the perfect balance right after the output process is completed while discharging the non-pressurized Hydraulic Fluid 18 back into the Hydraulic Fluid Tank 17.

7. that with the use of C-M3 the G-Force Emulator, with U.S. patent application Ser. No. 12/288,988, P3M3 can be made compact, lighter and a high RPM machine replacing fossil-fuel-feed engines or similar combustion powered engines by using hydraulic fluid or similar elements and can be used in outer space since gravity is replaced by C-M3.

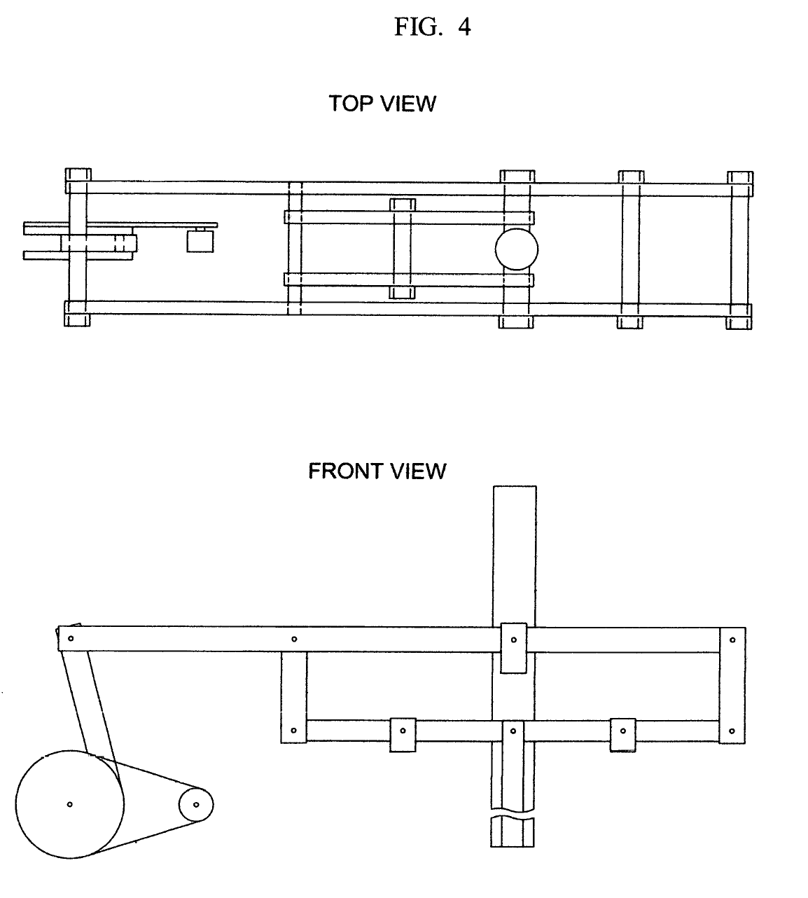

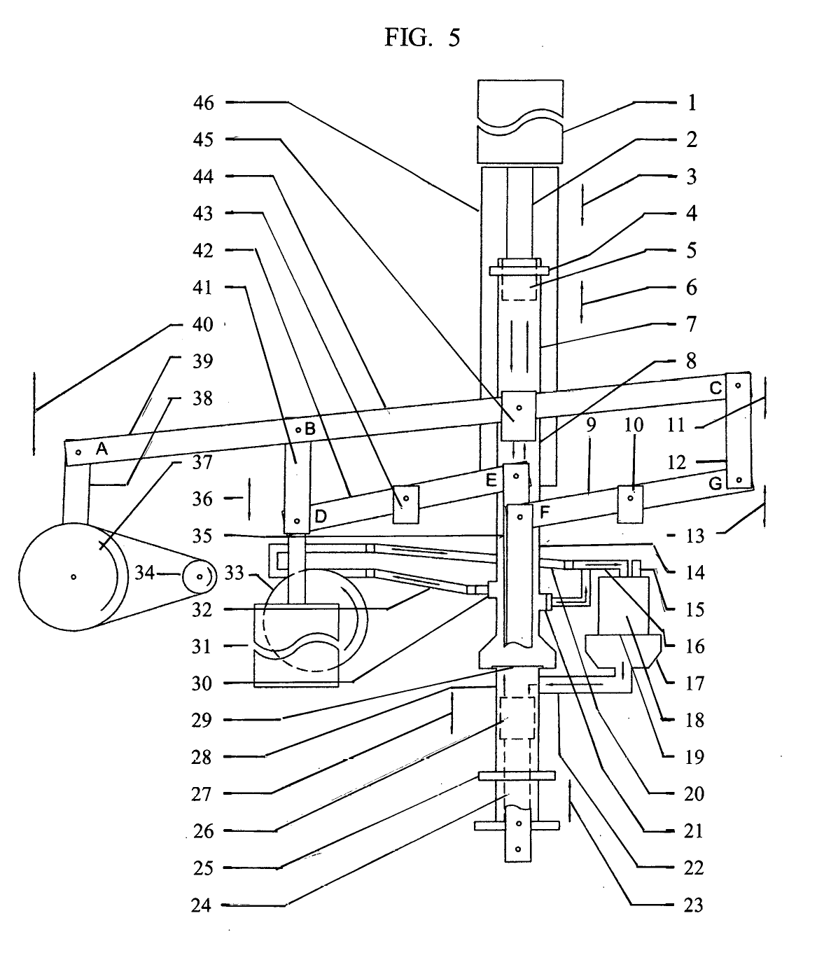

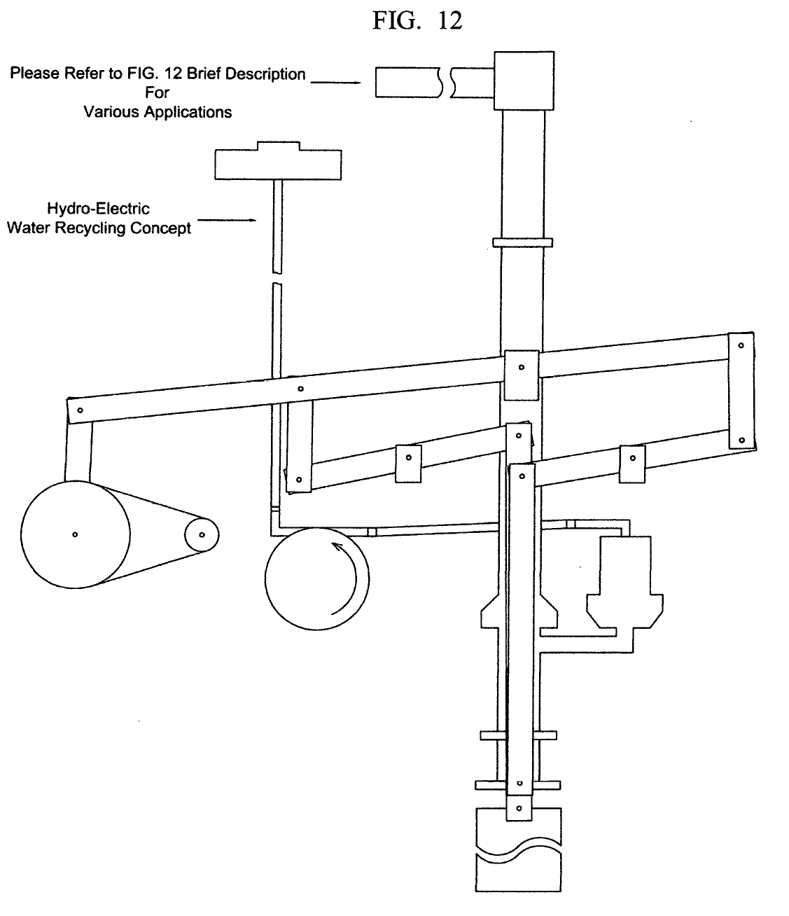

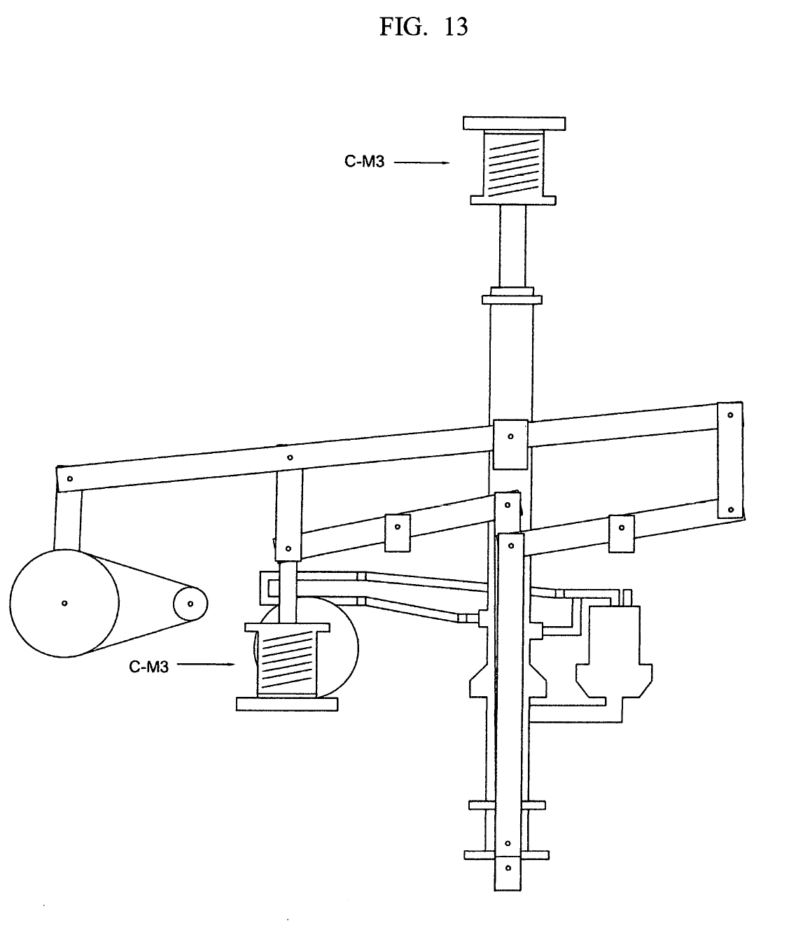

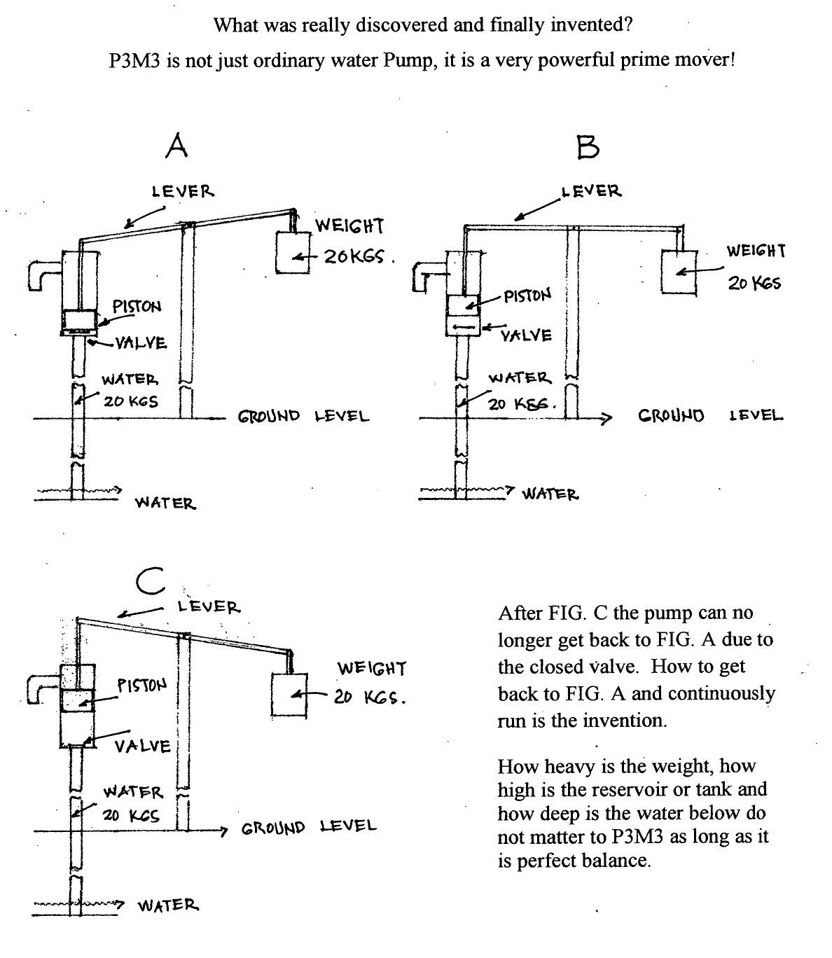

8. that P3M3 Tri-Lever Technology has numerous usage: as a water or liquid pump (please refer to FIG. 12)—to supply water for: electric generators using the hydroelectric water recycling concept; highland urban and rural areas; irrigation for highland farming; high rise buildings, hotels and condominiums; highland reservoir for fighting forest fires; fire-fighting equipment; cooling system for centralized air conditioning and ice plant; to pump out water from flooded or below sea level areas; decongest sewer lines; etc.; as air pump—to pump air for pneumatic tools; as a liquid pump—to extract oil or gas from the depths of the earth; as a machine using weights (please refer to FIG. 4): to run electric generators using the hydroelectric hydraulic fluid recycling concept; cable cars; conveyors, etc.; as a machine using C-M3 (please refer to FIG. 13): as a prime mover for various applications in place of combustion engines, etc.
